(19) United States
(12) Patent Application Publication
(10) Pub. No.: US 2011/0205261 A1
(43) Pub. Date: Aug. 25, 2011

(54) PRINTER, PRINTING SYSTEM, AND PRINTING METHOD

(75) Inventor: Okiharu Matsuda, Shizuoka (JP)

(73) Assignee: TOSHIBA TEC KABUSHIKI KAISHA, Tokyo (JP)

(21) Appl. No.: 12/869,050

(22) Filed: Aug. 26, 2010

(30) Foreign Application Priority Data
Feb. 23, 2010 (JP) 2010-037885

(51) Int. Cl. B41J 3/00; G06K 7/01; G06K 7/14

(52) U.S. Cl. 347/2; 340/10.4; 235/375

(57) ABSTRACT

According to one embodiment, a printer includes a first reading module that reads product information indicating a product from an unspecified product tag located in the vicinity of the first reading module. The printer may further include an acquisition module that acquires related information of a product indicated by the product information, which is read by the first reading module, from a server which stores related information regarding respective products, and a storage module that stores the related information acquired by the acquisition module. Further, the printer may include a second reading module that reads the product information from a particular product tag located in the vicinity of the second reading module, and a read-out module that reads out the related information, from among the related information stored in the storage module.

### CROSS-REFERENCE TO RELATED APPLICATIONS

This application is based upon and claims the benefit of priority from Japanese Patent Application No. 2010-037885, filed on Feb. 23, 2010, the entire contents of which is incorporated herein by reference.

### FIELD

Embodiments described herein relate generally to a printer, a printing system, and a printing method.

### BACKGROUND

In general, a printing system which prints a discount label of a product (e.g., apparel) may read a product code, which indicates a product, from a bar code or the like printed on a product tag attached to each product of apparel by a printer with a scanner. Using the so-read product code, the printing system may send an inquiry about related information (e.g., discount information or the like) regarding the product to a storage unit within the printer or a host device. As such, the printing system may acquire the related information from the storage unit within the printer or from the host device, and print the acquired related information.

### BRIEF DESCRIPTION OF THE DRAWINGS

FIG. 1 is a block diagram showing the configuration of a printing system in one embodiment.

FIG. 2 is a diagram showing an example of a master file.

FIG. 3 is a schematic diagram showing the external appearance of a handy scanner according to one embodiment.

FIG. 4 is a diagram showing the internal structure of the handy scanner.

FIG. 5 is a diagram showing an example of an RFID tag on which a bar code is printed.

FIG. 6 is a diagram showing an example of a label with a backing sheet on which related information is printed.

FIG. 7 is a block diagram showing the configuration of the handy scanner.

FIG. 8 is a functional block diagram illustrating the configuration of the handy scanner.

FIG. 9 is a flowchart showing the process flow of acquiring a master file.

FIG. 10 is a flowchart showing the process flow of reading out related information.

### DETAILED DESCRIPTION

According to one embodiment, a printer may include a first reading module that reads product information indicating a product from an unspecified product tag located in the vicinity of the first reading module. The printer may further include an acquisition module that acquires related information of a product indicated by the product information, which is read by the first reading module, from a server which stores related information regarding respective products, and a storage module that stores the related information acquired by the acquisition module. Further, the printer may include a second reading module that reads the product information from a particular product tag located in the vicinity of the second reading module, and a read-out module that reads out the related information of the product indicated by the product information, which is read by the second reading module, from among the related information stored in the storage module.

Embodiments of a printer with a scanner, a printing system, and a printing method will now be described in detail with reference to the accompanying drawings. In one embodiment, as an example of the printer with the scanner, a handy scanner which may emit light on a bar code or the like printed on a product tag or the like and may read an image from the reflected light therefrom will be described.

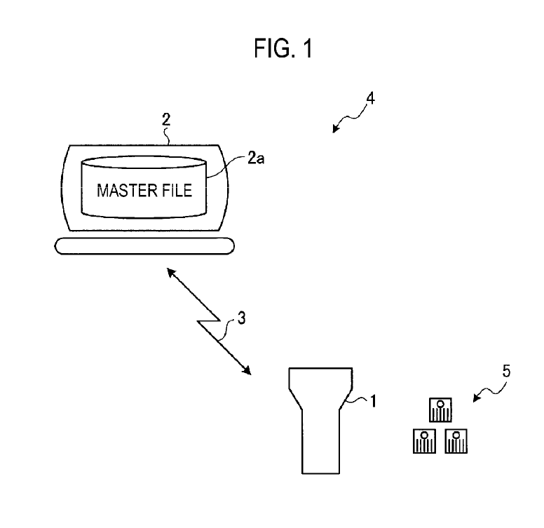

FIG. 1 is a block diagram showing the configuration of a printing system according to one embodiment. In one embodiment, the printing system 4 includes a handy scanner 1, a host computer 2 (e.g., server), and the like. For example, the handy scanner 1 and the host computer 2 may communicate to each other via a wireless LAN (Local Area Network) 3.

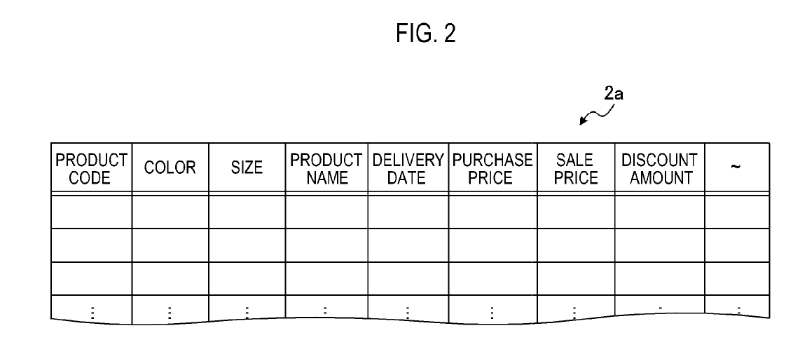

The host computer 2 may have a storage means or module (e.g., HDD (Hard Disk Drive) or the like) which stores a master file 2a of related information regarding respective products (e.g., apparel and the like). FIG. 2 illustrates an example of a master file. For example, as shown in FIG. 2, related information regarding various products may be recorded in association with product codes (product information) indicating products in the master file 2a. The related information may include, e.g., a color, a size, a product name, a delivery date, a purchase price, a sale price, a discount amount, or the like.

The handy scanner 1 may function as a reading means or module which reads a product code stored in an RFID (Radio Frequency Identification) tag 5 (e.g., product tag). Also, the handy scanner 1 may read a product code from print information of a bar code, a two-dimensional code, or the like printed on the RFID tag 5.

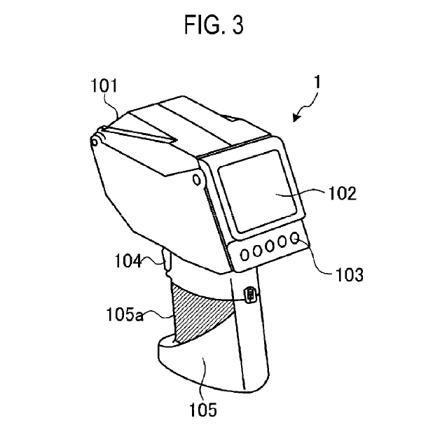

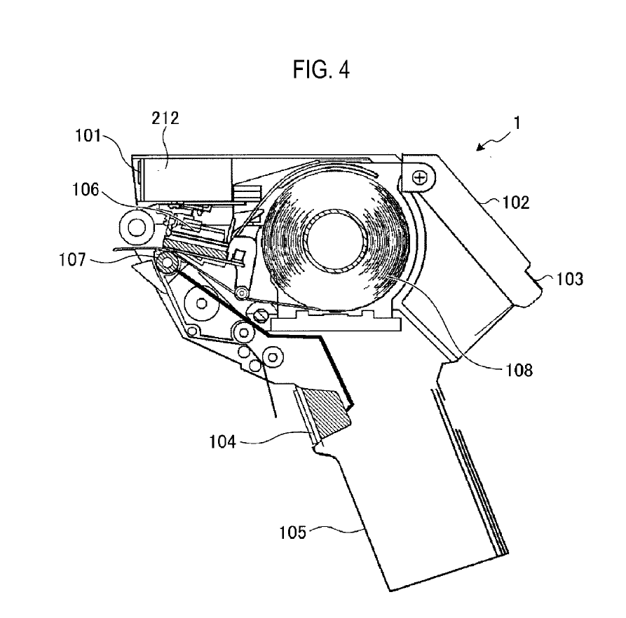

FIG. 3 shows the external appearance of the handy scanner. FIG. 4 shows the internal structure of the handy scanner. In one embodiment, the handy scanner 1 may include a scanner 101, a display 102, a key input unit 103, a trigger switch 104, a grip portion 105, a thermal head 106, a platen roller 107, a roll sheet 108, a reader/writer 212, or the like.

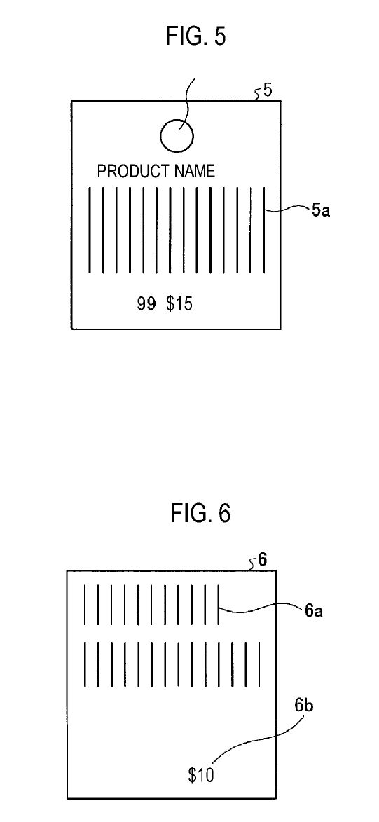

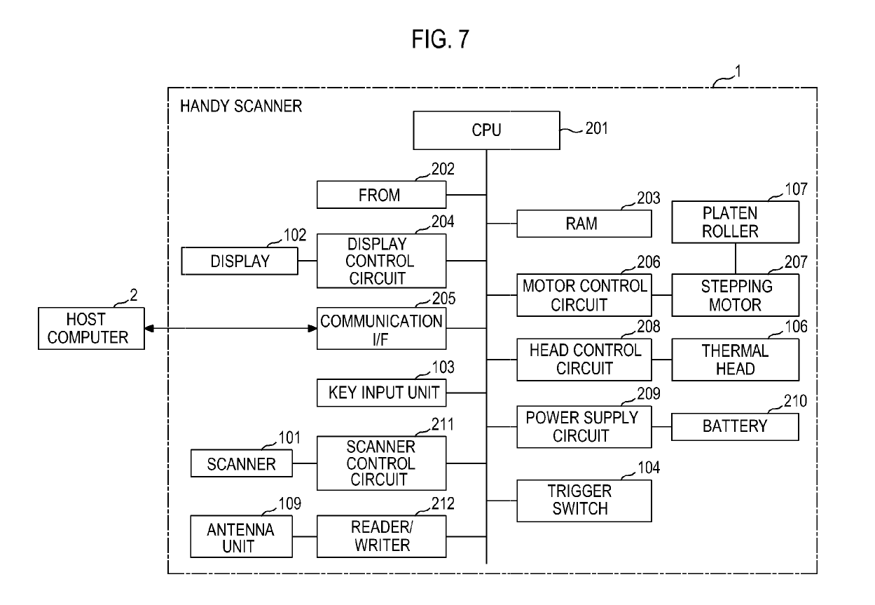

The reader/writer 212 (first reading means or module) may wirelessly communicate with an unspecified RFID tag 5 located in a range (within the proximity of the handy scanner 1) within which the product code stored in the RFID tag 5 is readable by the handy scanner 1 via an antenna unit 109 (see FIG. 7). Through the read/writer 212, the handy scanner 1 may read the product code stored in the RFID tag 5. FIG. 5 illustrates an example of an RFID tag on which a bar code is printed. In one embodiment, the reader/writer 212 may use a frequency band of, e.g., 2.45 GHz (a frequency band belonging to UHF) to read a product code from an unspecified RFID tag attached to a product located, e.g., within a range of 30 cm to 1 m.

The scanner 101 (second reading means or module) may emit light on a bar code 5a printed on a particular RFID tag 5 located in a range (in the proximity of the handy scanner 1) where a product code is readable by the reader/writer 212. The scanner 101 may read the product code from the reflected light of the bar code. Although the scanner 101 that emits light to the bar code 5a or the like and reads the product code from the reflected light is used in this embodiment, without limiting thereto, any variety of scanner's configurations may be adopted as long as the product code can be read from the particular RFID tag 5. For example, it is possible to use another reader/writer which may read a product code from the RFID tag 5 located in a range which is narrower than the range where the product code is readable by the reader/writer 212. For example, it is possible to use a reader/writer which uses a frequency band of, e.g., 13.56 MHz to read a product code from an RFID tag attached to a product located within a range of several tens of cm. Alternatively, it is possible to emit infrared light on the bar code 5a printed on the RFID tag 5 and read a product code from the reflected wave therefrom. Otherwise it is also possible to read a product code by reading and analyzing image data using a CCD (Charge Coupled Device) scanner.

The display 102 includes a liquid crystal display or the like which may display product information or operation information (e.g., a menu for selecting related information to be printed). The key input unit 103 may allow a user to input the operation information or the like.

The grip portion 105 corresponds to a portion by which the user grips the handy scanner 1. A portion indicated by reference numeral 105a may be formed of, e.g., a conductive polymer material. The portion indicated by reference numeral 105a may discharge static electricity induced on the handy scanner 1 through a human body in contact with the corresponding portion by means of the conductivity which is the property of the conductive polymer material.

The trigger switch 104 arranged on the grip portion 105 may be used to request the scanner 101 to read a product code. Upon pressing the trigger switch 104, the scanner 101 may read the product code from the bar code 5a printed on the RFID tag 5 attached to the product.

The platen roller 107 may be arranged to be opposed to the thermal head 106 to be described later (see FIG. 4). The platen roller 107 may be a conveying roller which draws out a label with a backing sheet from the roll sheet 108 on which the label with the backing sheet is wound and conveys the drawn-out label with the backing sheet to a print position of the thermal head 106. The platen roller 107 may be formed of, e.g., a conductive polymer material, thereby securing the conductivity.

The thermal head 106 may apply heat to the label with the backing sheet conveyed by the platen roller 107 to the print position, to thereby print related information. FIG. 6 shows an example of a label with a backing sheet on which related information is printed. As shown in FIG. 6, the thermal head 106 may print a bar code 6a (indicating a product code) and related information 6b (such as a discount amount or the like) on a label 6 with a backing sheet.

FIG. 7 is a block diagram showing the configuration of the handy scanner. In one embodiment, the handy scanner 1 includes a CPU (Central Processing Unit) 201 which may execute various arithmetic processes to centrally control respective parts/units. The CPU 201 is connected to a storage means or module such as a RAM (Random Access Memory) 203 and a FROM (Flash Read Only Memory) 202 as a nonvolatile storage unit capable of retaining stored content even when a power supply is turned off, via a system bus.

The FROM 202 may store an operation program or various setting information of the handy scanner 1. The CPU 201 may control respective parts/units by copying an operation program (including a program which executes a process of acquiring the master file 2a and a process of printing related information) stored in the FROM 202 to the RAM 203, and executing the operation program.

The RAM 203 (storage unit) may temporarily store various types of variable information, and store the master file 2a that is acquired from the host computer 2.

The RAM 203 may be used as a print buffer to present print data (image data) of related information to be printed on a label with a backing sheet. The print data may correspond to (i) data that is received from the host computer 2 as a print target, (ii) data stored in the FROM 202, (iii) a discount amount input from the key input unit 103, or the like.

The CPU 201 may be connected to a display control circuit 204, a communication interface 205, a motor control circuit 206, a head control circuit 208, a power supply circuit 209, a scanner control circuit 211, and the key input unit 103, and the trigger switch 104 via a system bus.

Under control of the CPU 201, the display control circuit 204 may control a display operation of the display 102. The display operation may include operating e.g., a menu or the like including a graphical interface for selecting related information to be printed on a label.

The communication interface 205 may provide an interface for wirelessly communicating with an external device such as the host computer 2 via the network 3. For example, the communication interface 205 may be arranged by a wireless LAN or the like, and make it possible to wirelessly communicate with a communication interface installed in the host computer 2.

Under control of the CPU 201, the motor control circuit 206 may control a stepping motor 207 which is a drive source of the platen roller 107. Under the control of the CPU 201, the head control circuit 208 may output a print control signal to the thermal head 106. Under the control of the CPU 201, the scanner control circuit 211 may control an operation of reading a product code by the scanner 101.

The power supply circuit 209 may control whether to supply power from a battery 210 to respective parts/units of the handy scanner 1 according to ON/OFF states of the power supply of the handy scanner 1 by the key input unit 103.

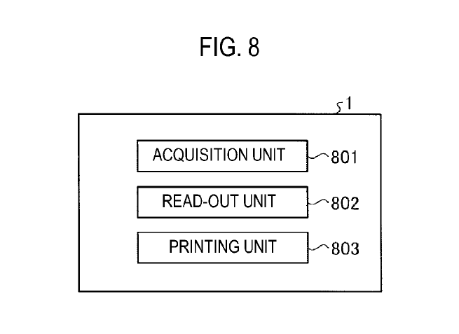

Hereinafter, functions to be implemented by the CPU 201's executing the operation program stored in the FROM 202 will be described with reference to a functional block diagram shown in FIG. 8. FIG. 8 illustrates a functional block diagram of the handy scanner according to one embodiment.

In one embodiment, a program to be executed by the handy scanner 1 may have a module configuration including an acquisition unit 801, a read-out means or module such as a read out unit 802, a printing means or module such as a printing unit 803, or the like as shown in FIG. 8. In the actual hardware configuration, the CPU 201 may read out a program from the FROM 202 and execute the program to load the above-described units on the RAM 203, thereby generating the units (the acquisition unit 801, the read-out unit 802, the printing unit 803, or the like) on the RAM 203.

The acquisition unit 801 may be configured to acquire the master file 2a for a product indicated by a product code that is read by the reader/writer 212 from the host computer 2. The acquisition unit 801 may store the acquired master file 2a to the RAM 203 if the same master file as the acquired master file 2a is not stored in the RAM 203. Otherwise, if the same master file as the acquired master file 2a is already stored in the RAM 203, the acquisition unit 801 may discard the acquired master file 2a. The acquisition unit 801 may delete the master file 2a from the RAM 203 when a predetermined time (e.g., 5 minutes) has elapsed after the master file 2a was stored in the RAM 203.

In this way, the handy scanner 1 does not need to be equipped with a storage device (e.g., HDD or the like) having a large storage capacity to store the master file 2a for products, thereby making it possible to implement the handy scanner 1 having a small size and a light weight. Since the handy scanner 1 is not necessarily provided with large-capacity storage, it is possible to avoid imposing excessive attention to a user who performs the work using the handy scanner 1. A user does not need to periodically update related information stored in the handy scanner 1, thereby making it possible to reduce the burden on the user. It is also possible to shorten a time necessary for printing related information by saving time for making an inquiry to the host computer 2, since the handy scanner 1 does not necessarily need to make the inquiry to the host computer 2 when printing related information that is already recorded on the master file 2a.

When the user, who is responsible for issuing related information such as a discount amount or the like, moves to a place to perform the operation of issuing the related information and presses the trigger switch 104 or operates the key input unit 103, the scanner 101 may read a product code from the bar code 5a printed on the RFID tag 5. Upon reading the product code by the scanner 101, the read-out unit 802 may read out related information of a product indicated by the read product code from among related information recorded on the master file 2a stored in the RAM 203.

When a printer with a scanner makes an inquiry about related information to a host device in a wireless or wired fashion, if a communication error such as disturbance noise occurs between the printer with the scanner and the host device, the retransmission of related information or the reconnection by roaming is necessary, and an acquisition time of related information is necessarily required. In one embodiment, however, it is possible to read out related information of a product indicated by a product code read by the scanner 101 without making an inquiry to the host computer 2, thereby making it possible to shorten a time necessary to read related information.

When the read-out unit 802 may read out related information of a product indicated by a product code from among the related information recorded on the master file 2a that is stored in the RAM 203, the read-out unit 802 may not make an inquiry directed to the host computer 2. Meanwhile, when the read-out unit 802 may not read out related information of a product indicated by a product code from among the related information recorded on the master file 2a stored in the RAM 203, the read-out unit 802 may transmit the product code read by the scanner 101 to the host computer 2, to thereby acquire the master file 2a for the product indicated by the product code read by the scanner 101.

The printing unit 803 may convert the related information read out by the read-out unit 802 into print data. The printing unit 803 may control the thermal head 106 through the head control circuit 208, and print the print data of the related information on a label with a backing sheet. The user of the handy scanner 1 may attach the label 6 with the backing sheet (see FIG. 6), on which the related information is printed, to the product.

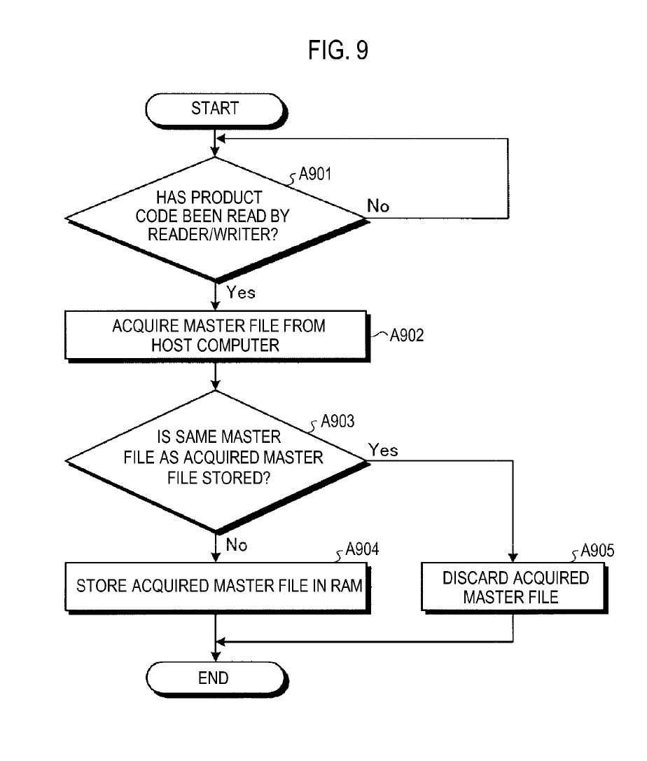

FIG. 9 is a flowchart showing the process flow of acquiring a master file. The acquisition unit 801 may be configured to determine whether or not a product code has been read from the RFID tag 5 by the reader/writer 212 (act A901). If the product code has been read from the RFID tag 5 (in case of “YES” in act A901), the acquisition unit 801 may acquire the master file 2a of related information of a product indicated by the read product code from the host computer 2 (act A902).

The acquisition unit 801 may determine whether or not the same master file as the acquired master file 2a is already stored in the RAM 203 (act A903). If the same master file as the acquired master file 2a is not stored in the RAM 203 (in case of “NO” in act A903), the acquisition unit 801 may store the acquired master file 2a in the RAM 203 (act A904). On the other hand, if the same master file as the acquired master file 2a is stored in the RAM 203 (in case of “YES” in act A903), the acquisition unit 801 may discard the acquired master file 2a (act A905).

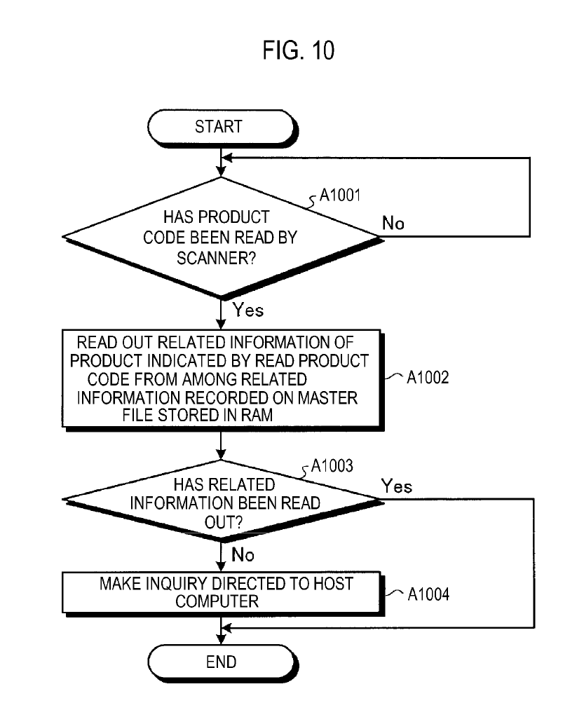

FIG. 10 is a flowchart showing the process flow of reading out related information. The read-out unit 802 may determine whether or not a product code has been read by the scanner 101 (act A1001). If the product code has been read by the scanner 101 (in case of “YES” in act A1001), the read-out unit 802 may read out related information of a product indicated by the so-read product code from among related information recorded on the master file 2a that is stored in the RAM 203 (act A1002).

If the read-out unit 802 may read out the related information of the product indicated by the read product code from among the related information recorded on the master file 2a stored in the RAM 203 (in case of “YES” in act A1003), the read-out unit 802 may provide the read-out related information to the printing unit 803 and end the read-outing process. On the other hand, if the read-out unit 802 may not read out the related information of the product indicated by the read product code from among the related information recorded on the master file 2a stored in the RAM 203 (in case of “NO” in act A1003), the read-out unit 802 may transmit the product code read by the scanner 101 to the host computer 2 to thereby acquire the master file 2a for the product indicated by the product code read by the scanner 101 (act A1004).

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus and can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS (Operating System) or the like in the apparatus.

As described above, in one embodiment, the printing system 4 may include the handy scanner 1 and the host computer 2 which stores related information regarding respective products. The handy scanner 1 may include the reader/writer 212 which reads a product code from the unspecified RFID tag 5 located in the vicinity of the reader/writer 212, the acquisition unit 801 which acquires related information of a product indicated by the product code read by the reader/writer 212 from the host computer 2, the RAM 203 which stores the acquired related information, the scanner 101 which reads the product code from the bar code 5a printed on the particular RFID tag 5 located in the vicinity of the scanner 101, the read-out unit 802 which reads out the related information of the product indicated by the product code read by the scanner 101, and the printing unit 803 which prints the related information read out by the read-out unit 802. Accordingly, it is possible to store related information of a product located in the vicinity of the handy scanner 1 into the handy scanner 1 and to read related information of a product indicated by a product code read by the scanner 101 without making an inquiry to the host computer 1. Thus, the printing system 4 is able to print related information at high speed even though the storage capacity of a storage device to store the related information is small.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a first reading module that reads product information indicating a product from an unspecified product tag located in the vicinity of the first reading module;
an acquisition module that acquires related information of a product indicated by the product information, which is read by the first reading module, from a server which stores related information regarding respective products;
a storage module that stores the related information acquired by the acquisition module;
a second reading module that reads the product information from a particular product tag located in the vicinity of the second reading module; and
a read-out module that reads out the related information of the product indicated by the product information that is read by the second reading module, from among the related information stored in the storage module.

2. The printer of claim 1,
wherein the product tag is a wireless tag storing the product information, and
wherein the first reading module is configured to read the product information from an unspecified wireless tag located in the vicinity of the first reading module.

3. The printer of claim 2,
wherein the second reading module is configured to read the product information from a particular wireless tag located in the vicinity of the second reading module.

4. The printer of claim 1,
wherein the second reading module is configured to read the product information from print information that is printed on the product tag.

5. The printer of claim 1, further comprising a printing module that prints the related information that is read out by the read-out module.

6. The printer of claim 2,
wherein the first reading module comprises a reader/writer which wirelessly communicates with the unspecified wireless tag located in a predetermined range.

7. The printer of claim 6,
wherein the reader/writer uses a frequency band of 2.45 GHz to read a product code from the unspecified wireless tag attached to a product located within a range of 30 cm to 1 m from the reader/writer.

8. The printer of claim 3,
wherein the second reading module is configured to emit light to a bar code printed on a particular wireless tag located in a predetermined range, and to read the product code from the reflected light of the bar code.

9. The printer of claim 3,
wherein the second reading module is configured to read a product code from the particular wireless tag located in a range narrower than the range where the product code is readable by the first reading module.

10. The printer of claim 9,
wherein the second reading module uses a frequency band of 13.56 GHz to read a product code from the particular wireless tag attached to a product located within a range of several tens of cm from the second reading module.

11. The printer of claim 2,
wherein the wireless tag includes a RFID tag.

12. A printing system comprising:
a first reading means for reading product information indicating a product from an unspecified product tag located in the vicinity of the first reading means;
an acquisition means for acquiring related information of a product indicated by the product information, which is read by the first reading means, from the server;
a storage means for storing the related information acquired by the acquisition means;
a second reading means for reading the product information from a particular product tag located in the vicinity of the second reading means; and
a read-out means for reading out the related information of the product indicated by the product information that is read by the second reading means, from among the related information stored in the storage means.

13. The printing system of claim 12, further comprising a server which stores the related information regarding respective products.

14. The printing system of claim 12, the printer further comprising a printing means for printing the related information that is read-out by the read-out means.

15. A printing method for use in a printer with a scanner, which includes a storage module for storing related information regarding products, the printing method comprising:
a first reading act of reading, by a first reading module, product information indicating a product from an unspecified product tag located in the vicinity of the first reading module;
an acquiring act of acquiring related information of a product indicated by the product information read by the first reading act, from a server which stores related information regarding respective products;
a second reading act of reading, by a second reading module, the product information from a particular product tag located in the vicinity of the second reading module; and
a read-out act of reading out the related information of the product indicated by the product information that is read by the second reading act, from among the related information stored in the storage module.

16. The printing method of claim 15 wherein the acquiring act comprises acquiring a master file of the related information from the server, and storing the master file into the storage module.

17. The printing method of claim 15 wherein the read-out act comprises determining whether or not the product information is read by the second reading module, and if the product information is read by the second reading module, reading out the related information of the product indicated by the read product information from among related information stored in the storage module.

18. The printing method of claim 17 wherein the read-out act is performed by a read-out module, and if the read-out module may read out the related information, the read-out module provides the read-out related information for printing.

19. The printing method of claim 17 wherein the read-out act is performed by a read-out module, and if the read-out module may not read out the related information, the read-out module transmits the product information read by the second reading module to the server to thereby acquire a master file for the product indicated by the product information read by the second reading module.

20. The printing method of claim 15 further comprising a printing act of printing, by a printing module, the related information that is read out by the read-out act.
